(19) United States
(12) Patent Application Publication
(10) Pub. No.: US 2012/0287638 A1
(43) Pub. Date: Nov. 15, 2012

(54) LASER ILLUMINATING DEVICE

(75) Inventor: HSIN CHIN CHEN, Tainan City (TW)

(73) Assignee: ACMOS TECHNOLOGY CO., LTD, Tainan City (TW)

(21) Appl. No.: 13/184,705

(22) Filed: Jul. 18, 2011

(30) Foreign Application Priority Data
May 11, 2011 (CN) 201120148094.9

(51) Int. Cl. G02B 27/20

(52) U.S. Cl. 362/259

(57) ABSTRACT

A laser illuminating device, assembled with a telescope, comprises a laser emitting means for emitting a laser light, a divergent lens disposed on a laser traveling path of the laser light, and a light shape trimming member for trimming a light shape of the divergent laser light. The trimmed laser light will be projected to an observing field of the telescope to clearly and evenly illuminate an object to be observed.

### FIELD OF THE INVENTION

The present invention relates to an illuminator, and more particularly to a laser illuminating device.

### BACKGROUND OF THE INVENTION

A telescope, which is an instrument for visual observation or photography that collects a visible light, is used for magnifying an image by focusing the collected visible light.

The telescope meets the difficulty in collecting a visible light, which is reflected from an object, as observed at night time, because of the usually insufficient visible light at the night time.

For solving above problems, an illuminator may be extra provided to project a light to the object to be observed, and thus the telescope is able to collect enough visible light reflected from the object to be observed.

However, in the case that the object to be observed is far from the telescope, a conventional illuminator in a prior art, due to divergence of the light thereof, can not provide sufficient light that the telescope requires. Besides, the light from the conventional illuminator in a prior art is usually uneven. For example, in some cases, the light density in a middle portion of illuminating visible light, is usually brighter than that in a surrounding side edge portion thereof. In other cases in the conventional illuminator, it may occur the irregularity of light distribution shat several light regions and dark regions distributes irregularly

Since the conventional illuminator has limited ability in projecting light, is desired to provide an illuminator which can project an even light.

### SUMMARY OF THE INVENTION

In view of the above, the conventional illuminator has limited ability in projecting light so the conventional illuminator is not properly suitable for being used as an illuminator of a telescope in illuminating light for an object in a far distance.

Therefore, it is an object of the present invention to provide a laser illuminating device, acting as an illuminator of a telescope, to project an even light at night time for illuminating object in a far distance.

The present invention overcomes the drawbacks of the prior art, and provides a laser illuminating device, which is assembled on a telescope, comprising: a laser emitting means; a divergent lens disposed on a laser traveling path of a laser light emitted from the laser emitting means; and a light shape trimming member, disposed on the laser traveling path of the laser light passing through the divergent lens, formed with a limiting orifice having a cross section area smaller than a light projecting area where the laser light is projected on the limiting orifice, one side of the limiting orifice facing the laser light and the other side of the limiting orifice facing an observing field of the telescope.

In a preferred embodiment of the present invention, the laser emitting means, the divergent lens, and the limiting orifice of the light shape trimming member are collinear.

In a preferred embodiment of the present invention, the laser illuminating device further comprises a convergent lens disposed on the laser traveling path of the laser light passing through the divergent lens.

In a preferred embodiment of the present invention, the laser light has available wavelengths.

In a preferred embodiment of the present invention, the divergent lens is a biconcave lens.

In a preferred embodiment of the present invention, the limiting orifice has a circular shape.

In a preferred embodiment of the present invention, the divergent lens is further coupled with an adjusting member for adjusting a position of the divergent lens. Said adjusting member further interworks with a focusing means of the telescope.

In a preferred embodiment of the present invention, the laser illuminating device is a flashlight.

In a preferred embodiment of the present invention, the laser illuminating device is a light projector.

A source of light used in the laser illuminating device in the present invention is a laser having a centralized light projecting area. The laser is diverged by lenses so as to make an illuminating area of the laser illuminating device become wide, and the laser is further trimmed by the light shape trimming member so as to make the laser to have a definite light shape. Thus, an object to be observed can be illuminated clearly and evenly by a light projected by the laser illuminating device even if the object is far from the laser illuminating device.

Further, the laser illuminating device in the present invention has an advantage in low cost and is easy to miniaturize due to its simple structure.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating an embodiment of the present invention;

FIG. 2 is a side view illustrating an embodiment of the present invention;

FIG. 3 is a cross section view illustrating a laser illuminating device in the embodiment of the present invention;

FIG. 4 is a schematic drawing illustrating an illuminating area produced by projecting a diverged laser light on a plane;

FIG. 5 is a schematic drawing illustrating an illuminating area produced by projecting a trimmed laser light on a plane;

FIG. 6 is a cross section view illustrating a laser illuminating device in an embodiment of the present invention; and

FIG. 7 is a perspective view illustrating another embodiment of the present invention.

### DETAILED DESCRIPTION OF THE PREFERRED EMBODIMENTS

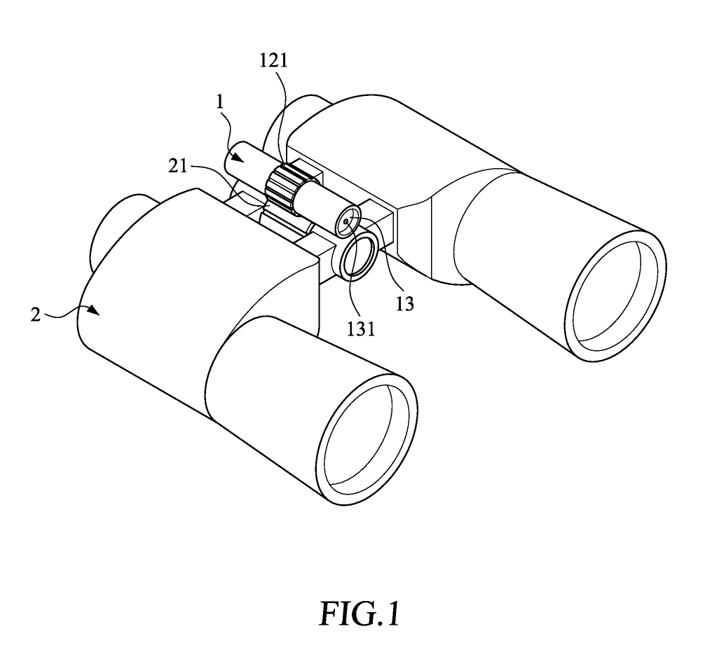

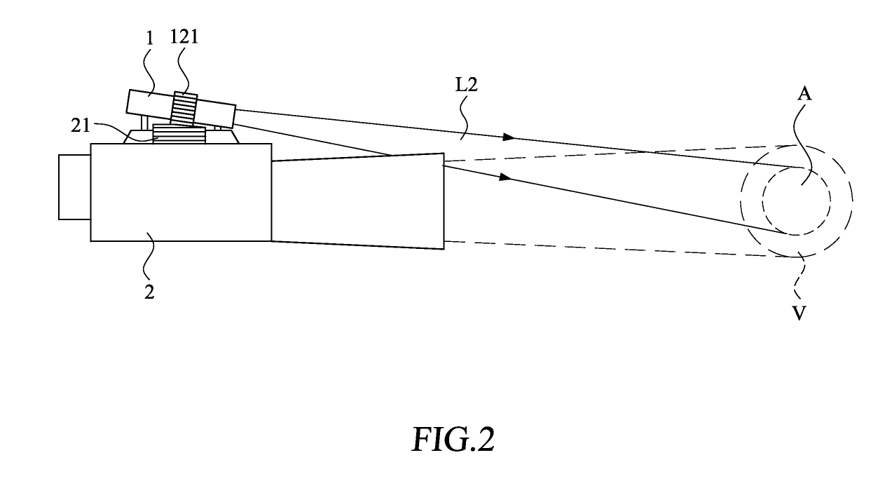

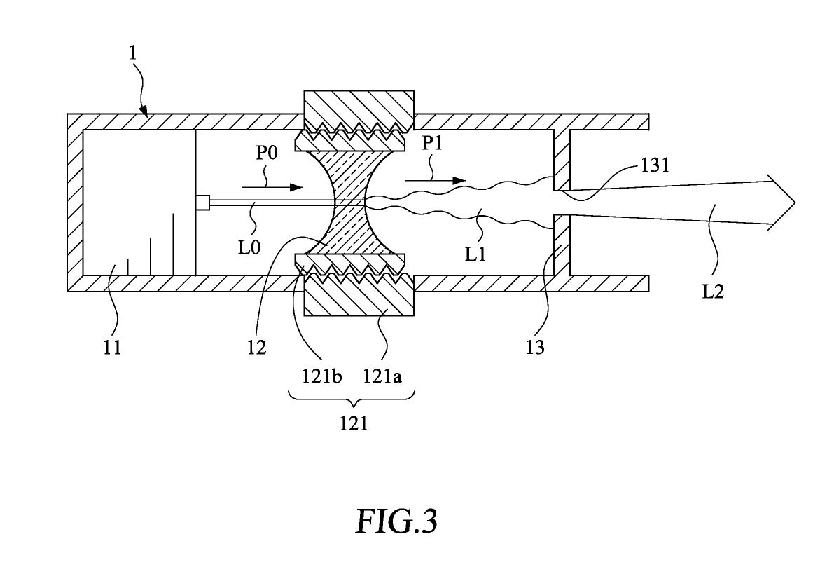

Please refer so FIGS. 1-3. FIG. 1 is a perspective view illustrating an embodiment of the present invention; FIG. 2 is a side view illustrating an embodiment of the present invention; and FIG. 3 is a cross section view illustrating a laser illuminating device in the embodiment of the present invention. In the present invention, the laser illuminating device 1, assembled with a telescope 2 includes a laser emitting means 11, a divergent lens 12, and a light shape trimming member 13.

The laser emitting means 11 is a means for emitting a laser light. For example, the laser emitting means 11 may be a laser diode. Preferably, the laser light emitted by the laser emitting means 11 has available wavelengths which can be seen by human eyes. The laser light L0 emitted by the laser emitting means 11 will travel along a laser traveling path P0.

The divergent lens 12 is disposed on the laser traveling path P0 of the laser light L0 emitted by the laser emitting means 11. The laser light L0 will be diverged into a diverged laser light L1 after passing through the divergent lens 12. The divergent lens 12 in this embodiment is a biconcave lens. However, the present invention is not limited to this, and a plane-concave lens or a convex-concave lens may also be provided as the divergent lens 12 in order that the laser light can be diverged after passing through the divergent lens 12.

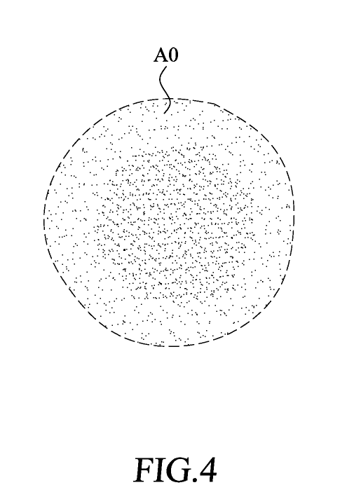

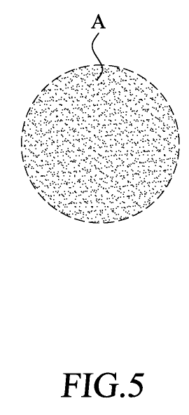

The light shape trimming member 13 is disposed on the laser traveling path P1 of the diverged laser light L1 passing through the divergent lens 12. The light shape trimming member 13 is formed with a limiting orifice 131 which has a size smaller than that of a light projecting area where the diverged laser light L1 is projected on the limiting orifice 131. That is, an illuminating area produced by projecting the diverged laser light L1 on the limiting orifice 131 is larger than a cross section area of the limiting orifice 131. It is found that a surrounding side edge portion of an illuminating area A0 produced by projecting the diverged laser light L1 on a plane is more blurred than a middle portion thereof (as the illuminating area A0 illustrated in FIG. 4) after the laser light is diverged by the divergent lens 12. With above structure, the surrounding side edge of light shape of the laser light L1 can be masked, so as to trim off the blurred surrounding side edge portion. Thus, the laser light L1 will become a trimmed laser light L2 having a light shape with a clear surrounding side edge (an illuminating area A produced by projecting the trimmed laser light L2 on a plane is illustrated in FIG. 5) after passing through the limiting orifice 131. It is preferred, that the limiting orifice 131 has a circular shape similar with light shape of the laser light, so that the light shape of the laser light will be trimmed as circular shape after the laser light passes through the limiting orifice 131. Because the laser light L2 has an even brightness and the side edge of light shape thereof is clear, a brightness difference is outstanding between a region on which the laser light L2 is projected and a region adjacent to it, so that it makes the laser light L2 easy to be focus on an object to be observed in illuminating the object to be observed.

One side of the light shape trimming member 13 faces the laser light L1 and the other side of the light shape trimming member 13 faces an observing field V of the telescope 2, so that the trimmed laser light L2 passing through the limiting orifice 131 can be projected toward the observing field V of the telescope 2 to illuminate an object to be observed in the observing field V, and the object to be observed can be observed easily by use of telescope 2.

Preferably, the divergent lens 12 may be coupled with an adjusting member 121, so that the divergent level of the laser light can be adjusted by adjusting a position of the divergent lens 12 on the laser traveling path with the use of the adjusting member 121. The adjusting member 121 may include an outer ring part 121a and an inner ring part 121b. The outer ring part 121a is screw fastened with the inner ring part 121b, and the inner ring part 121b is fastened to the divergent lens 12. When the outer ring part 121a rotates, the inner ring part 121b is moved parallel to the laser traveling path so that the position of the divergent lens 12 is adjusted. However, the present invention is not limited to this. The adjusting member 121 may have other structure. Further, the adjusting member 121 may be provided to interwork with a focusing means 21 of the telescope 2. Thereby, when focal length of the telescope 2 is adjusted by the focusing means 21 (synchronously, the observing field of the telescope 2 is adjusted), the illuminating area A of the laser illuminating device 1 can be adjusted synchronized with the adjustment of observing field.

Besides, the laser emitting means 11, the divergent lens 12, and the limiting orifice 131 of the light shape trimming member 13 can be collinear. Alternatively, a structure in which a reflection mirror (not illustrated) is disposed between two elements of the laser illuminating device to change the laser traveling path of a laser can be provided.

with the above mentioned structure, the laser illuminating device is capable of projecting a clear and even light. Further, she laser illuminating device also has an advantage in low cost and is easy to miniaturize because it has a simple structure.

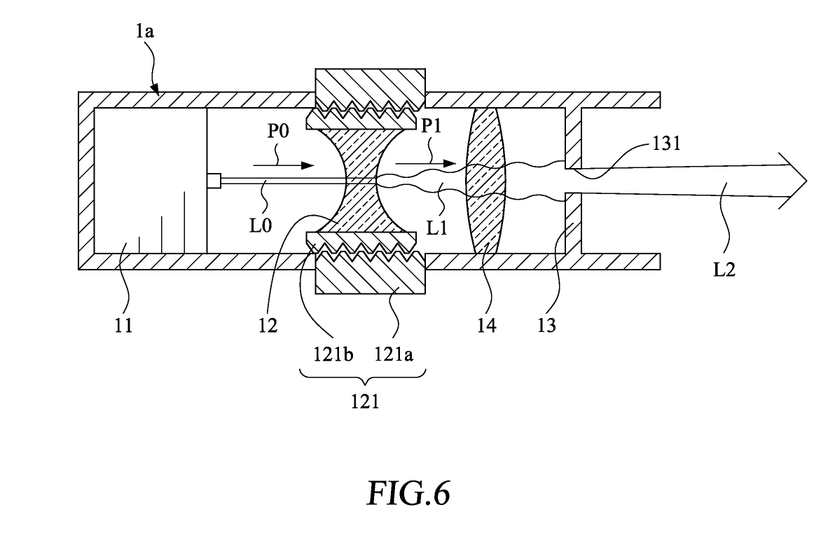

Please refer to FIG. 6, which is a cross section view illustrating a laser illuminating device in an embodiment of the present invention. The elements of a laser illuminating device 1a in this embodiment are similar with those in the above embodiment, and the same elements in this embodiment are labeled with the same reference numbers as in the above embodiment.

The laser illuminating device 1a in this embodiment is further provided with a convergent lens 14 disposed on the laser traveling path P1 of the laser light L1 passing through the divergent lens 12. The laser light L1 can be converged by the convergent lens 14, so that a divergence angle of the laser light L1 can be further adjusted so as to regulate the illuminating area A of the laser light L1 as appropriate.

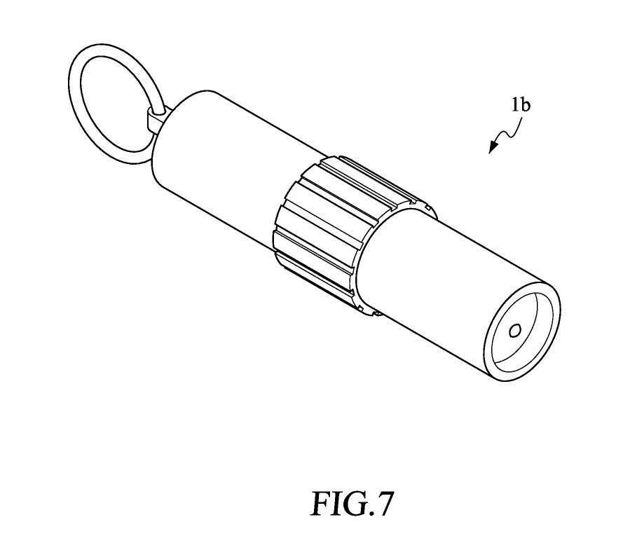

Note that although the laser illuminating device in the above embodiment is used as a light projector assembled with the telescope 2, the laser illuminating device may be disassembled from the telescope 2 as appropriate, so that the laser illuminating device can be used as a flashlight (as a laser illuminating device 1b illustrated in FIG. 7).

As can be appreciated from the above embodiments, the laser illuminating device of the present invention has industry worth which meets the requirement for a patent. The above description should be considered as only the discussion of the preferred embodiments of the present invention. However, a person having ordinary skill in the art may make various modifications to the present invention. Those modifications still fall within the spirit and scope defined by the appended claims.

What is claimed is:

1. A laser illuminating device, assembled with a telescope, comprising:
a laser emitting means;
a divergent lens disposed on a laser traveling path of a laser light emitted from the laser emitting means; and
a light, shape trimming member, disposed on the laser traveling path of the laser light passing through the divergent lens, formed with a limiting orifice having a cross section area smaller than a light projecting area where the laser light is projected on the limiting orifice, one side of the limiting orifice facing the laser light and the other side of the limiting orifice facing an observing field of the telescope.

2. The laser illuminating device as claimed in claim 1, wherein the laser emitting means, the divergent lens, and the limiting orifice of the light shape trimming member are collinear.

3. The laser illuminating device as claimed in claim 1, further comprising a convergent lens disposed on the laser traveling path of the laser light passing through the divergent lens.

4. The laser illuminating device as claimed in claim 1, wherein the laser light has available wavelengths.

5. The laser illuminating device as claimed in claim 1, wherein the divergent lens is a biconcave lens.

6. The laser illuminating device as claimed in claim 1, wherein the limiting orifice has a circular shape.

7. The laser illuminating device as claimed in claim 1, wherein the divergent lens is further coupled with an adjusting member for adjusting a position of the divergent lens.

8. The laser illuminating device as claimed in claim 7, wherein the adjusting member interworks with a focusing means of the telescope.

9. The laser illuminating device as claimed in claim 1, wherein the laser illuminating device is a flashlight.

10. The laser illuminating device as claimed in claim 1, wherein the laser illuminating device is a light projector.
